(19) United States
(12) Patent Application Publication
(10) Pub. No.: US 2007/0027919 A1
(43) Pub. Date: Feb. 1, 2007

(54) Dispute resolution processing method and system

(76) Inventor: Missy Sue Mastel, San Francisco, CA (US)

Correspondence Address: JACKSON & CO., LLP, 6114 LA SALLE AVENUE, SUITE 507, OAKLAND, CA, 94611-2802, US

(21) Appl. No.: 11/319,765

(22) Filed: Dec. 27, 2005

Related U.S. Application Data
(60) Provisional application No. 60/696,333, filed on Jul. 1, 2005.

(51) Int. Cl. G06F 17/00

(52) U.S. Cl. 707/104.1

(57) ABSTRACT

A computer-implemented dispute resolution method includes receiving a dispute query from a user and generating a record based on the dispute query. A decision is electronically generated, including applying the record to a workflow algorithm including representations of one or more business rules, one or more segmentation or decision trees or both, one or more expression sequences, one or more data structures, one or more user-defined functions, and/or one or more decision models. It is determined whether to gather further information or take other further action based on said decision. The record is updated according to the decision, and stored. A result of the dispute query is communicated to the user based on the record.

### CROSS-REFERENCE TO RELATED APPLICATION

This application claims the benefit of priority to U.S. provisional patent application No. 60/696,333, filed Jul. 1, 2005.

### BACKGROUND

1. Field of the Invention

This invention relates to a dispute resolution processing method and system. More particularly, the invention relates to a method and system that receives information from the World Wide Web (Web), accesses data sources external to the system, generates decisions based on decision trees, models, and rules, stores information and returns decisions to the Web using a tracking process and time guidelines guaranteed by the system.

2. Description of the Related Art

The recent rapid growth of the Internet and World Wide Web (Web) has expanded opportunities for electronic business methods and systems, including the telecommunications industry. However, although a great deal of information is available on the Internet, much of the business decision-making, including how to settle customer disputes, takes place off-line. For example, when a consumer places a dispute with a telecommunications carrier for a billing error or a question about a fee on his bill, the carrier may or may not identify a particular group or department for the customer to manage his complaint, and that department may perform dispute resolution functions in addition to other functions, like technical support, customer service, or sales. Typically, the customer will call a customer service department, which will open up a ticket using descriptive notes. Information about how much the customer spends with the carrier may be added (e.g., is this a good customer?). The ticket number is communicated to the customer. The customer is usually put on hold or called back if the billing department or supervisors are involved. The department then may or may not send the item to other personnel, who gather up information related to the dispute and the customer from a variety of sources and other personnel, and then may note the customer's file and may or may not contact the customer directly with the result. The customer may accept the result, or may challenge the result, which is generally a manual process involving either an omsbudsman or legal department at the carrier. This process can be done more efficiently over the Web, and it is desired to provide a system and methods for doing so.

It would be advantageous and is desired to use the secure Internet to streamline such processes of the telecommunications and other businesses who handle customer disputes using personnel and other non-Web resources.

It would be advantageous and is desired to apply an expert decision-making process to refine and expedite customer service and dispute resolution.

It would be advantageous and is desired to have an operation environment that is in ASP (Application Service Provider) mode, preferably using Extensible Markup Language (XML).

It would be advantageous and is desired to have an operations environment to store previous decisions and elements used in the decision-making process as transaction data. It is desired to have a system that provides storage beyond mere storage by end users who maintain such data on their own systems.

It is also desired to have a system and method for combining the two fields of technical support and arbitration. It is desired to provide a system and method including a combination that uses technical support to manage arbitration.

### SUMMARY OF INVENTION

The invention provides a dispute resolution decision-making method and system that allows an end user to deliver to a customer, such as, for example, a consumer of telecom or utility services, a resolution to their dispute at the customer's email address, based on criteria entered about the dispute, that is formalized and consistent with stored rules, e.g., stored in look-up tables.

The method and system may involve receiving information from the Web, accessing external data sources, generating a decision based on decision trees, models, or rules, sorting information related to the decision(s) and/or returning the decision to the end-user's Web using a tracking process and/or time guidelines guaranteed by the system.

A computer-implemented dispute resolution method is provided including receiving a dispute query from a user and generating a record based on the dispute query. A decision is generated electronically by applying the record to a workflow algorithm including representations of one or more business rules, one or more segmentation or decision trees or both, one or more expression sequences, one or more data structures, one or more user-defined functions, or one or more decision models, or combinations thereof. It is determined whether to gather further information or take other further action based on the decision, and the record is updated according to the decision. The record is stored and a result is communicated to the user based on the record.

The generating of the record may include inputting information relating to the dispute query to a secure gateway for translation of the information, and populating the record with translated information.

When it is determined to gather further information prior to generating a decision, then the method may further include gathering the further information. The further information may include user account information or history or both, type or amount of the dispute or both, external report information, consumer statistics, tariff or regulatory information or both, one or more contracts, or combinations thereof. The method may further include ordering the further information using the internet and/or retrieving the further information from one or more internal resource locations. Other further action may involve a human specialist.

The method may include testing the workflow algorithm. Results may be documented of the testing for use in an audit and/or the workflow algorithm may be updated based on results of the testing.

A microprocessor-based apparatus is configured within a computer network for receiving a dispute query, generating a decision regarding the query, and communicating a result of the query. The apparatus includes one or more microprocessors and one or more digital memories having stored therein a computer-implemented design component architecture. The architecture includes designer and reporting facility components, as well as a run-time server and program requester. The designer component is for configuring a decision engine including a workflow algorithm. The reporting facility component is for generating configuration or testing reports, or both, relating to operation of the decision engine. The run-time server is for executing the decision engine by applying the dispute query to the workflow algorithm for generating the decision. The program requester is for generating one or more modules representing one or more business rules, one or more segmentation or decision trees or both, one or more expression sequences, one or more data structures, one or more user-defined functions, or one or more decision models, or combinations thereof, to be integrated as part of the workflow algorithm.

The one or more digital memories may further have stored therein a record generator that inputs information relating to the dispute query to a secure gateway for translating the information, and that populates the record with translated information.

The one or more digital memories may further have stored therein an information gathering component for gathering further information before communicating the result including user account information or history or both, type or amount of the dispute or both, external report information, consumer statistics, tariff or regulatory information or both, one or more contracts, or combinations thereof. The gathering may include ordering the further information using the internet and/or retrieving the further information from one or more internal resource locations

The designer component may be configured to update the workflow algorithm based on results of the testing.

The program requester may include a C requester.

A further dispute resolution method is provided for determining and delivering a decision to an end user based on a dispute query received from the end user using decision trees, models, rules or external reports, or combinations thereof. The method includes providing a secure internet gateway for receiving the dispute query from the end user and subsequently translating the query for processing. Translated information of the query is inserted into a standard record which is passed to a decision system. The query information is analyzed using decision trees, models, or rules, or combinations thereof. A resolution is generated based on the analyzing, and the standard record is updated with the generated resolution. It is determined whether the dispute query requires further action based on the resolution. The standard record is passed directly to a relational database for storage when it is determined that no further action is required. Some or all of the resolution is passed through the gateway to the end user.

The standard record may be passed to a secondary review system when it is determined that further action is required. The method may include analyzing the standard record and determining additional information that is required, as well as determining whether additional information has been received. When it is determined that the additional information has not been received, then a message may be placed in the standard record indicating delay. When it is determined that the additional information has been received, then data may be passed from the additional information in the standard record. The method then returns to passing the standard record to a decision system. The method may include invoking appropriate protocols for each of the additional information.

The method may involve multiple end users, multiple actions, and multiple dispute resolution actions and decisions.

The gateway may be operated in ASP mode, and/or a XML interface may be utilized.

The database may include data elements generated during the analyzing, the dispute query, and/or the translated information. The method may include utilizing the database for reporting, tracking, or future analysis, or combinations thereof. Decision trees, models or rules, or combinations thereof may be updated based upon the utilizing of the database.

The method may also include accessing an initial dispute resolution process or a secondary process, or both, for handling continuing disputes or arbitration or mediation transactions, or combinations thereof. The accessing may be dependent upon one or more external data requirements. The dispute may relate to a billing charge or process, or service.

One or more processor readable storage devices are also provided having processor readable code embodied thereon. The processor readable code programs one or more processors to perform any of the herein-described dispute resolution methods.

### BRIEF DESCRIPTION OF THE DRAWINGS

FIG. 1 is a schematic diagram illustrating main components of a system in accordance with a preferred embodiment.

FIG. 2 is a flow diagram illustrating a flow of events of a method in accordance with a preferred embodiment.

### DETAILED DESCRIPTION OF THE PREFERRED EMBODIMENTS

A dispute resolution decision-making method and system are described that allow a carrier to deliver to a recipient, such as, for example, a business or residential consumer of telecommunications services, a decision on a dispute entered by an end user based on the consumer's criteria, and other rules, trees, and decision models that are gathered from external data sources and applied within an ASP model and guaranteed to be delivered under agreed-upon time frames. Information is preferable transmitted via the Web, external data sources are accessed, a decision is generated based on trees, models and rules, information is stored relating to the decision, and the decision is returned to the end user's Web site. The system and method enable the carrier or business to harness the power of the Internet to develop more efficient dispute resolution practices and more efficient and reliable customer service techniques.

The preferred embodiment operates in Application Service Provider (ASP) mode using XML interface. A secure Internet Web site is utilized, thereby ensuring the privacy of customer strategies and customer and end user data. The amount of hardware and software the consumer and carrier purchases and maintains is also minimized or optimized. It can also be appreciated that the system can run at a carrier's Web site. It can also be appreciated that a Virtual Private Network (VPN) can also be used.

The preferred embodiment provides a refined process by applying business rules, decision trees, and models in a different way from industry standard. That is, for example, the decision to grant a consumer billing credit for a specific billing issue or service issue is arrived at by more sophisticated and reliable analysis, thereby rendering a decision that more accurately reflects the situation, and is sustainable and repeatable.

The preferred embodiment enables the carrier to deliver to the consumer a resolution at the consumer's email address based on the dispute criteria and policies in place at the carrier. The resolution process returns a decision based on decision trees, rules, and/or models previously implemented in a host dispute resolution system application.

The preferred embodiment uses transaction information, such as, for example, consumer spending with the carrier and the type and amount of the dispute, transmitted through the Web site. External report information, such as for example, tariff and tax regulation, may also be obtained and used in the generation of the decision(s). The dispute application, consumer statistics, and regulatory information may be captured and decision elements retuned using an XML Interface. The automation of the process allows for a guaranteed timing on the result and/or regular status updates to the end user and the customer. A Service Level Agreement is preferably offered to the end user for resolution on their dispute.

The preferred embodiment preferably, but not necessarily, includes the following logical blocks: data capture from the consumer via ASP web site; comparison of data elements to business rules, decision trees, and/or models; access to external reports; generation of recommended decision(s) using end user criteria; storage of information related to the decision (s); and/or transmission of recommended decision(s) to the end user Web site.

The preferred embodiment implements business rules, decision trees, and/or models preferably, but not necessarily including the following information: specification of business rules; specifications of models; specifications of strategies, such as, for example, decision trees; external data available on the Web and/or within customer databases, including specific tariffs, contracts, regulatory information, and/or ordering and provisioning codes; specifications of data transmitted from the customer; and/or specifications of data to be transmitted to the end user, including guarantees as to service timelines, and resolution of the dispute.

The preferred embodiment implements the end user business rules, decision trees, and/or models by incorporating them into the appropriate logical blocks. During the implementation process, connections with external data sources are verified for validity. Accordingly, the carrier provides test cases so that business rules, decision trees, and/or models can be audited. The customer is responsible for documenting correct decisions for each of the test cases. The customer is responsible for determining when enough test cases have been audited. Business rules, decision trees, and/or models are updated based on new specifications provided by the customer.

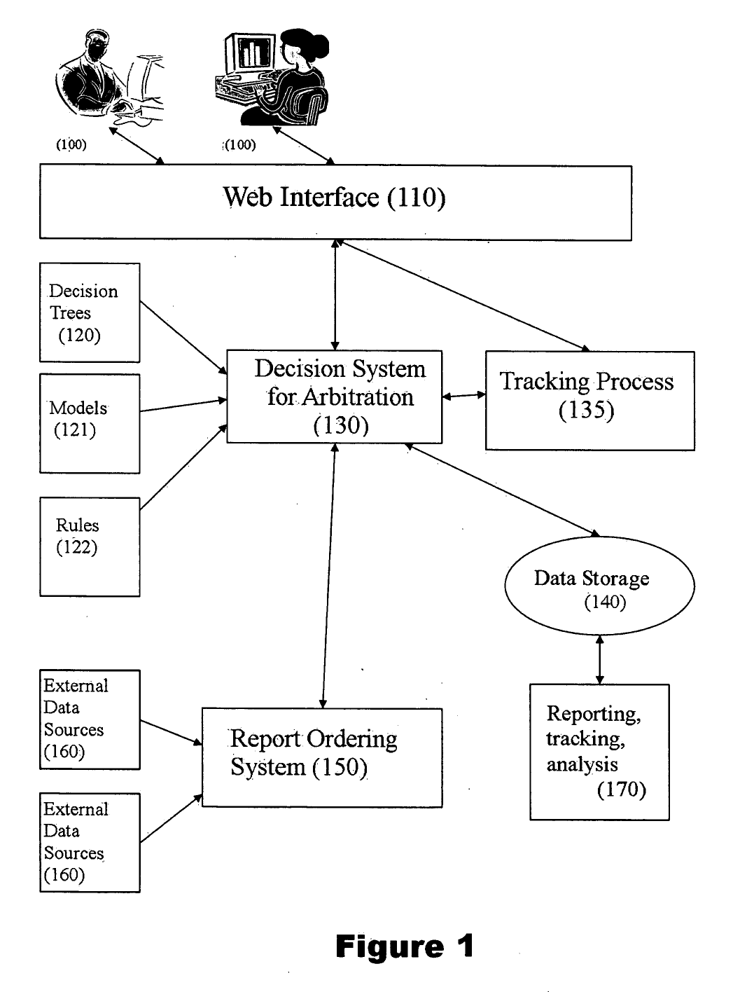

A preferred embodiment is described with reference to FIG. 1. The preferred embodiment receives XML transaction information from consumer computers 100. Multiple end user computers 100 represent the capability of the preferred embodiment to accept information from multiple sources over the Internet.

The end users access the World Wide Web (Web) using a standard connection, described in gateway 110. The preferred embodiment of the system accesses a secure Web site via forms provided at the Web site or other methods for uploading the information into the system. It is at this stage in the process that XML transactions are translated in such a way that each element from the transaction is placed into a standard record.

In the preferred embodiment, prior to end users 100 transmitting transactions, decision trees 120, models 121 and rules 122 are designed and entered into an expert decision-making or decisioning entity 130, such as a module or system of modules. The preferred embodiment incorporates a rules-based decision-making system. Those skilled in the art will appreciate that other expert decision-making systems may be substituted, and that the invention is applicable to industries other than the telecommunications industry.

As the standard record enters the decision system 130, a tracking process that reviews the completeness of the record and the date of entry is initiated. This tracking process sets up a calendar for each of the processes, and may return to the consumer via the gateway 110 a Service Level Agreement relating a guarantee as to completion of the record review and resolution. An exemplary decision system is discussed in a separate section herein below.

As the standard record enters the decision system 130, elements from the standard record are analyzed using the decision trees 120, models 121, and rules, 122. The result of the applied decision trees 120, models 121, and rules 122 is then reviewed. If it is determined that the result does not require further action, then the standard record, now enhanced with the resolution to the dispute, is stored in relational database 140. The appropriate results are returned through the gateway 110 back to the requestor 100 in XML format.

If it is determined that the result does require further action, then the record is passed to a report ordering system or set of modules 150. This system analyzes appropriate fields in the standard record to determine which external reports to order. The report ordering communicates with the customer and obtains tariff or regulatory information, contracts, or other information, as needed. The report ordering system 150 then invokes appropriate protocols corresponding to each reports external data source 160 as requested by the standard record. When external reports are available and sent to the report ordering system 150, the external reports are stored in the relational database 140. Also, appropriate fields from such reports are placed into the standard record, which is then sent back to decision system 130 for review. When external reports are not available, i.e., when external computers are down, messages indicating delay are placed into the standard record, and the system administrator is notified that expedites in other areas may be required under certain time constraints. When reports are successfully retrieved, the reports are stored in relational database 140. The full standard record is then sent back to system 130 for review.

The relational database 140 of the preferred embodiment houses all of the processed transactions, including, but not limited to, data elements initially input, data elements on external reports from external sources 160, and/or data elements generated during the decision-making process.

The preferred embodiment uses the relational database 140, such as computer module or system of modules, for performing reporting, tracking, and future analysis 170. The preferred embodiment also uses the relational database 140 to further refine and improve, but is not limited to, the decision trees, models, and rules.

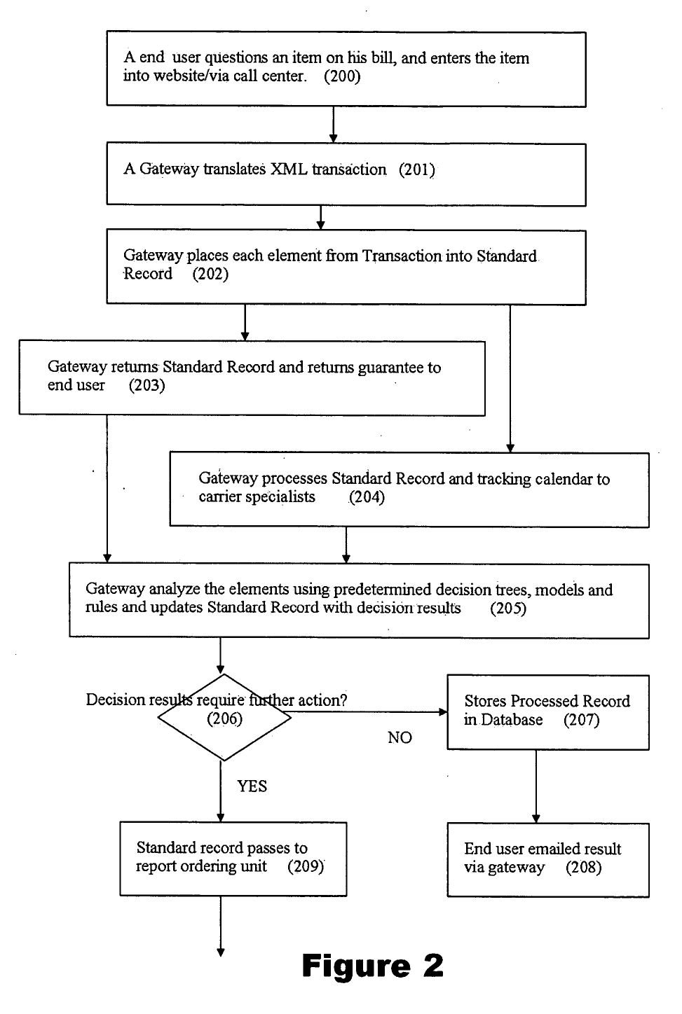

FIG. 2 is a flow diagram showing a flow of events according to a preferred method. The method or process begins with receiving an XML transaction from an end user (200) and inputting it into a secure gateway (201). The gateway then translates the XML transaction (201) and places each element from the translation transaction information into a standard record (202). The standard record is passed to an expert decision system (203). The decision system analyzes the elements of the standard record using pre-determined decision trees, models, and rules, and updates the standard record with decision result(s). (204) Whether or not the decision result(s) requires further action is determined (205). If it is determined that the decision result(s) does not require further action, then the standard record is stored in a relational database (206) and an appropriate result(s) is returned through the gateway to the end user in XML format (207). If it is determined that the decision result(s) does require further action, then the following events occur. The standard record is passed to a report ordering logical unit (208). This unit analyzes the appropriate elements and determines which, if any, external information to order (209). If the ordered external information is not received, then a message indicating such is placed in the standard record (211) and control is returned to determining when the external report or review is complete. If the external report or review is received, then the full report is stored in the database (212) and appropriate elements from the external report(s) are placed in the standard record. Control is returned to passing the standard record to the decision-making system (203). The process ends when the decision system determines that the decision result(s) does not require further action (205) and the subsequent steps (206 and 207) are taken.

### An Exemplary Decision System

The Decision Engine

A preferred embodiment includes a decision engine, accessed over the Internet in ASP mode or neatly and natively integrated into an enterprise workflow on its appropriate target platform. Waiting for a request, it idles; and when called from other programs, the decision engine revs up and promptly responds to questions for decisions. The fuel for the engine is data. A calling program prepares and sends data to the decision engine; and, in real time, the engine processes it and returns a reply that may include reason codes, actions, tariff and regulatory references, and other calculated results or decisions.

A customer can easily assemble the basic design of the engine, and can build upon the framework of a decision process template or a copy of a previously designed engine. The details of the engine can be informed from at least three sources including preferably (1) customer models, expertise, policies, and judgment, and (2) Mass-Tel Communications models and strategies built upon the end user's historical data with Mass-Tel Communications prodigious domain expertise, and/or (3) models and strategies built upon the a third party's historical and compiled data with prodigious domain expertise.

The decision engines that can be fashioned are entirely configurable in design. A customer can create new decision processes to help address new business problems, or can experiment with existing decision processes, improving decisions over time through controlled champion/challenger testing. Champion/challenger testing is where the customer can compare competing strategies in a statistically valid way so that the customer can determine which strategy produces the best results. The existing strategy is the champion, the new strategy is the challenger. As a new strategy proves its effectiveness, it can be applied to a greater percentage of the customer's data. When a challenger becomes a new champion, a strategy design cycle begins.

Component Architecture

The preferred embodiment is preferably architected for integration with an end user's existing systems. The decision engine may be accessed over the Internet or executed in the end user's mainframe, UNIX, or NT platforms. That is, the customer's existing systems will be able to accommodate new or newly revised engines with minimal IT involvement.

The customer can build upon the component architecture and create a new alternative design-time user interfaces that are customized to present a particular business context to a particular set of users. Furthermore, the customer can automate the importation of existing models or strategies into decision engines that the end user creates.

Components

The preferred embodiment may include the following components:

Designer: A visual development environment that enables the end user to create and configure design engines.

Reporting Facility: Web-based design-time configuration reports and run-time testing results.

Run-Time Server: A Microsoft NT-based server that supports the run-time execution of the configured decision engines. End user operational systems can make calls or requests to this server, and the server executes the decision engine to process the request and returns results to the requesting system.

C Requester (Optional for customer installation mode): Tool generates a C module that represents the business rules, strategies and decisions of the configured decision engine. The code of the module can be uploaded to a target platform, compiled, and called a module via a C function call form the end users requesting systems. In an alternative embodiment, this requester can also be programmed in COBOL.

Use of Models

The customer can incorporate models into the decision system environment. Along with other rules and criteria, the customer can use models to predict or describe many types of customer behavior, including the likelihood to respond to a settlement offer, expected end user revenue/profit/lifetime value, or the likelihood to click-through for purchase of corollary items offered on the Web-site.

Models can be predictive judgmental (expert) pooled, regulatory or policy compliant predictive, or custom developed from historical data. They can be decision models that aim to arrive at optimal decisions, given their context. A wide range of models can be developed for the decision system.

ASP Mode Review

A preferred embodiment operates in ASP mode. When accessed in ASP mode, Mass-Tel Communications hosts the software, so that the customer isn't concerned with the time, cost and technical details of the installation, servicing and upgrading of the hardware OS or OS software on which it runs. The software is accessed from the end user's computer, be it residential or commercial used, using internet gateway industry standard protocols or over a Virtual Private Network. Thus, the software is highly scalable and easy to integrate with the customer's current computing and operational environment.

In the ASP environment, the customer designs decision engine projects from a customer PC, which is connected to designer software resident at the host site. Once the customer completes design of a project, the host generates the supporting code and installs it on a decision server. In parallel with this, the host generates XML schema that corresponds to the project, and is used to define the input and output structures that the customer's business application uses when making attempts at the decision server. When accessed over the Internet, the customer's PC sends inquiry transactions to the host's Web server, which in turn passes those transactions through the decision logic in the associated project and returns via the Web server.

Applied Business Rules

The preferred embodiment allows for defined customer business rules to be executed through the decision system. Business rules are first defined within a decision system project. A project can comprise any of the following features: input and output data structures; characteristic generations; models; reason codes; business rules and exclusions; decision strategies; and/or recommended actions.

Designer Overview

The preferred embodiment includes a designer feature that allows the end user to create and refine projects by defining and combining individual project parts in an almost limitless number of combinations. From the designer, the end user can view and test a project configuration as it is being built. The designer can try different strategy methods and logic until they are perfected for the purpose of the customer in runtime. In the designer, the customer works within the context of a project. That is, when the project is created, the customer defines its parameters according to the needs of the project. For example, a customer can create a first project that makes dispute resolution decisions based on customer policies, can create a second project for determining breakpoints for credits offered based on end user revenue, and can create a third project for establishing deadlines for customer response to disputes. Each project has its own unique structure based on its purpose and the desired output.

Decision System Tasks

A customer performs tasks in the decision system that are separated into three types: design, test and runtime.

Design Tasks

Design tasks are used to define and build the project parts and workflow. Logic and business rules are gathered and assembled. Tools and functions are provided in the designer.

Testing Tasks

Testing provides a collective view of the behavior and results of one or more executions of the project against data sets. In order to test a project, the end user has a batch, or collection of test case records. As a set, these test case records can be run against a given design. The process of testing a project includes both validating the project in the designer, generating statistical results for each step in the overall workflow of the project, and viewing the statistics in a bulk testing report.

Runtime Tasks

Runtime involves a project that has been both designed and tested. The decision system's runtime mode consists of the processing of the disputes rules with the input data from runtime clients. At the end of execution, the output stream is generated.

Data Definitions

Defining data is central to defining a project and is one of the first things the customer does at the beginning of project design. An inventory view provides one view of the hierarchy, order, and contents of a data dictionary, which defines all of the data structures and data elements in the project, such as: the runtime input stream structure; constant values; intermediate derived values or temporary values that are calculated during a runtime process; and/or contents and structure of the output data stream.

The customer can create new data structures, add to and delete from existing data structures, and reposition data fields. The end user can perform all of these actions within the inventory view. The architecture supports the definition of hierarchical structures, which can be used in a variety of contexts, supporting, for example, the definition of data segments, value lists, and arrays.

Workflow Functional Components Overview

Workflow functional components define a process or action to be carried out. There are preferably three main workflow functional components: expression sequences; segmentation trees; and workflow lists.

Expression Sequences Overview

An expression sequence assigns values to local fields and permits modifying local field values. The expression assignment is an arithmetic expression or another field of compatible type. Specifically, these values can be: literal numbers or strings; UDFs; and/or evaluated expressions.

Segmentation Trees Overview

Segmentation trees can be integral parts used in the creation of a project workflow. One way to construct the project workflow is by arranging the workflows steps using segmentation trees. The customer can use segmentation trees to create complex decision-making branches resulting in: another decision-making branch; and a workflow list initiating further or terminating processes.

Workflow Lists Overview

A workflow list identifies a set of steps that are processed during runtime execution. They are referenced by a segmentation tree leaf node and are also available for reuse. Workflow lists appear in the inventory view in alphabetical order. The project workflow is the flow of execution of the project beginning with a specific workflow list designated as the root result list. Each list item of a workflow list points to a particular workflow functional component, such as an expression sequence or segmentation tree.

Other Resources Overview

The end user can incorporate models and UDFs into the project design. Such resources provide means to apply and implement user-defined logic within a project.

Models

Models are made up of characteristics and attributes and produce an predictive score at runtime for a given transaction. Tools are provided to define, edit, and manage models. Such tools also generate UDFs and other data structures within a project.

User Defined Functions

A UDF represents the logic to be contained in a single subroutine. The UDF functions to document the repeatable portions of the workflow. Examples include, but are not limited to, syntax and error checking, status bar formats, context-sensitive toolbars, popup menus, and as display options properties page. A customer can also cut, copy and paste text with a UDF.

The Project Workflow

The project workflow defines the use and the order of execution of the project parts. Specifically, it determines the way that data moves or flows through the project and the results. A workflow view displays project workflow configuration in a tree structure, allowing the end user to view the way in which project parts fit together and their order in the process.

Constructing the Workflow

The project workflow consists of workflow lists, segmentation trees, and expression sequences. The customer builds the flow with these parts, placing them in the order in which the customer would like them to execute. Usually the customer selects parts already existing in an inventory. But, the customer can also create such parts while building the workflow.

Tracing the Process Flow

The process includes steps that are executed in the right order. This minimizes or prevents the production of errors at runtime or simple failure to produce the desired results.

Example

The project workflow is arranged within a segmentation tree. The first segmentation tree implements and exclusion rule, and there are two leaf (result) nodes. The excluded data exits the workflow at the first result node and the remaining data continues through the workflow extending from the second result node.

Overview of Projects, Parts and Procedures

The dispute engine works with projects constructed from parts that apply business rules and logic. A project represents a process that is designed to receive data and produce recommendations, decisions, statistics, and the like.

Order of Input and Output

A project is designed as a decision engine, to take input and produce output. Thus, it is important for a customer to take input and output streams into consideration when designing a project.

Input and Output Streams

The data streams may include the following features: order of data; segment occurrences (max and actual); and fields that are automatically generated and are hidden (project ID and actual occurrences).

Input

The order of input data conforms to the order the end user has set in the decision system designer. Input data for a transaction is passed in a proper order.

Output

The order of the output also conforms to the order the end user has set within the designer.

Sequential vs. Hierarchical Design Approach

A sequential approach appears on the surface to be a most straightforward approach. In this approach, a project workflow follows an ordered list of steps, or sequence. Many customers may likely choose this approach by instinct, but it is usually not the best choice.

The biggest drawback to sequential design is that all data is re-evaluated at each decision node, resulting in slower performance. In this workflow, data that has been excluded earlier in the sequence continues to move through the workflow.

To a new user, the hierarchical approach seems less obvious, on the surface, but represents a better choice. In this approach, workflow components are set up in an hierarchical fashion, within a single workflow list and data is excluded as it moves through the workflow. The main advantage to this type of design is that exclusion data is separated from the project flow, so only valid information is evaluated at each decision node. This results in enhanced performance.

It is noted that while it is possible to calculate resolutions using segmentation trees and expression sequences, it is more efficient to process disputes using UDFs or models within a project.

Putting Parts Together in a Workflow

A project's main workflow includes segmentation trees, expression sequences, and/or workflow lists. Such segmentation trees, expression sequences and/or workflow lists can reference other project parts including data structures, UDFs and models, as well as other segmentation trees and expression sequences. A hierarchical list comprises part references in their order of execution at runtime. The customer builds a flow with these parts, placing them in the order in which there are to execute at runtime. Usually a customer selects from segmentation trees and expression sequences that exist in an inventory, but may also create parts as the customer builds the workflow.

The Root Workflow List

When a project is initially created, the system automatically creates a root or main Workflow list called a root workflow list. Such a list is a starting point for processing a runtime and defines the workflow of the entire project.

Expression Sequences Details

An Expression Sequence is one of the workflow functional components the end user can use to construct a project workflow in the designer. Like other functional components, they are reusable within the project. An expression sequence assigns values to local fields only. In the designer, expression sequences are presented in a three-column grid format. The first column holds an identifier or name of the local field on which an assignment is targeted. The second column holds the data type of the specified local field. The third column holds the value, field, or expression that results in a value that will be assigned to the local field. The rows in the grid are effectively in a sequence of expressions. The end user can use an expression sequence in the project workflow to specify return codes, return strings, or other information to be sent back to a client during runtime, as well as create values to be held in temporary fields.

Example

An express sequence is typically used for strategy assignments. For example, in defining a strategy for late payment credits, the end user uses expression sequences to return the type of response that will be sent to the customer. In an expression sequence defined as part of a result list at a particular leaf node in a segmentation tree, a “DecisionCode” local field may be set to the string “SK3”, which might represent a credit back of late fees. In another expression sequence within another result list attached to another leaf node, (say one that has examined past payment history as deficient) “LetterCode” local field might be set to the string “SP9” representing a denial of credit.

Expression Sequence Assignments

An expression sequence is a functional component that consists of a sequence of value assignments. Each assignment associates a local field with an expression. The assigned expression is an arithmetic expression of another field of compatible type. Values can be any of the following: literal strings; constants; local fields; input fields; derived fields; valid expressions (including VarGen); and user defined functions.

Segmentation Trees

Segmentation trees represent control flow logic, validation or policy rules, and strategy trees. Segmentation trees are often used as a main building block, or part, of a project's workflow. When the end user assembles the project workflow, the end user constructs the segmentation trees so that data moves in the order of workflow steps. The end user can incorporate segmentation trees at a step of a workflow.

The nodes of a segmentation tree are always executed top-down, from left-to-right. If a rule specified at a node is true, then processing continues with the next child node. If the rule is false, then processing continues with the next sibling to the right. The end user can use segmentation trees to create complex decision-making branches resulting in one of the following: another decision-making branch; and a workflow list initiating further processing.

Examples of Segmentation Trees

Segmentation Trees are useful for dividing a population into sub-populations. The end user implements a segmentation tree in a workflow so that each time it is called it returns to one sub-population. The end user can easily design a project so that, depending on the sub-population, a different series of workflow steps will be carried out. A segmentation trees can be simple with a single decision node that divides a population into two or more segments. It can also be quite complex, containing many possible paths and dividing a population into several segments. A more complex tree will typically contain subtrees, which are made up of all decision nodes within the tree and their child branches and nodes.

Exclusion Trees

Exclusion tress are useful for excluding data from processing. Adding this type of tree to an end-user's workflow enables the end user to remove undesirable data at the beginning of the workflow, and can save valuable processing time when implementing the decision engine.

Example

A carrier may not want an automated decision engine to make crediting decisions on amounts in excess of $5K. The carrier creates a simple exclusion tree to remove such credit requests from the processing pool at the beginning of the workflow.

Strategy Assignment Trees

Another type of tree that can be extremely useful in a decision engine design is an assignment tree. This type of tree assigns members of a population to specified categories based on any number of criteria that the end user specifies, thus enabling each group to be processed differently.

Example

An end user designs a decision engine for crediting late payment fees. The end user wants to use different criteria for selection depending on the number of times the account has been delinquent. The end user creates an assignment tree to assign each record with a late payment fee to different strategies based on their frequency of delinquency. Those accounts that are delinquent for the first time in 12 months receive a credit, and those accounts that are delinquent more than once in 12 months receive no credit for late fees charged.

Decision Trees

A decision tree is similar to a decision table, wherein two or more variables or conditions are identified in order to determine a result. Decision trees can segment data by assessing many different variables, applying scoring models, etc., and produce a final result, or decision, about an individual data record.

Segmentation Tree Nodes

A segmentation tree is, as its name implies, a tree structure used for segmenting data. The tree is made up of a series of paths (branches) and nodes. Nodes are points where some action or logic is applied, resulting in the data moving down another branch or exiting the tree. The nodes stemming from the branch is mutually exclusive and collectively exhaustive.

The Root Node

The preferred root node is the first node in the tree. It is preferably the parent node for all other nodes and branches within the tree. It cannot be deleted. A root node is created automatically when a new segmentation tree part is inserted into a project's inventory. It is the first decision node in the tree.

Decision Nodes

Decision nodes are the most basic type of node in a segmentation. A tree has at least one decision node, and the first is the root node. This node type has two or more descending branches attached to child nodes. There are four different types of decision nodes and a decision node's type is determined by the type of test it applies. A test determines if the data matches the specified criteria. If it does, the child node is executed next. If it does not, the sibling to the right is executed. This schema includes the root node, which is the first decision node in a segmentation tree. There are several decisions or tests that can be used to define the decision node's segmentation: boolean test (true or false); continuous subranges (<10, 10-19, 20-29,>29); discrete subsets (2,4,5,7; “pink”, “green”, “red”); and user defined segmentation (VarGen Expression).

If the node type is none of the above and ends the tree flow, it is an end result, or leaf node, type. Leaf nodes are also called external nodes, because they indicate that no further decisioning or segmenting will be applied to the data. Such nodes have a result list attached. When the end user defines a decision node and determines its branching, a new node is inserted at the end of each branch. If the end user defines the properties of the decision node as an end results node, the node becomes a leaf node.

Result Lists

A result lists is essentially a workflow list attached to a leaf node. This referenced list serves a series of processing steps to be applied to the data as it exits the segmentation tree.

Boolean Test Nodes

A Boolean decision node is used to specify a true/false rule. This enables the end user to test for a specific condition by using a single expression to be defined a true. This type of node automatically generates true and false branch nodes.

Continuous Subrange Nodes

A continuous subrange decision node is used to define rules wherein the end user identifies ranges of data. This enables the end user to specify subranges with each defining a single branch, or to specify multiple non-contiguous subranges within a branch. For example, an end user sends values that are below a specified number or above another specified number down an out of range branch, (i.e. an invoice date that has not occurred in time or is beyond the statute of limitations, or company policy, for credit requests).

Discrete Subset Nodes

A discrete subset decision node is used to specify rules of specific values or sets of values. This enables the end user to specify subsets, which represent one or more values, and are denoted by a decision variable that can be evaluated against a value list or constant, depending on the data type of the decision variable.

User-Defined Test Nodes

In most cases, the rules to be defined for a segmentation tree node fit within the categories of Boolean, continuous subrange, or discrete subset. However, an end user can create a user defined decision node to use custom expressions for defining a segmentation. One should ensure that the mutually exclusive and collectively exhaustive requirement for this test type are enforced.

End Results Nodes

An end results node is used to indicate an end to a decision branch. This type of node does not apply a test; it simply references a workflow list, a result list in this situation, to be executed. It cannot reference a root workflow list.

Workflow Lists

A workflow list is another functional component. It includes a list of rules to be executed. Each list item of a workflow list points to a particular workflow step, such as a segmentation tree or expression sequence. The reference to one of these functional workflow components within a list item invokes execution of that part as runtime.

The root workflow lists represents the main thread of execution for a project at runtime. Workflow lists can be used as a result list at an exit point of a segmentation tree. End result nodes in a segmentation tree point to a workflow list. More than one node in a tree and more than one tree in a project may point to the same list.

Structure of a Workflow List

The primary rule for creating a workflow list is that circularity is not permitted. For example, a workflow list item may not point to a segmentation tree in which a leaf node points to the same workflow list. A segmentation tree node may not point to a workflow list which contains any items that point to that tree.

The Root Workflow List

The project workflow displays and controls the flow of execution of the project, which begins with a workflow list that is designated as the root workflow list. Such part preferably cannot be deleted. It is special because it contains the main processing sequence for the decision engine. When the end user builds a workflow, the end user will reference a sequence of segmentation trees and expression sequences within this list. An end user can add, delete, and rearrange items in the list.

Building Workflow Lists

Building a workflow lists is a straightforward process. A workflow list can contain any of a number of steps. Each step can reference a segmentation tree or expression sequence. Steps can be created in any of multiple sequences.

Referencing Another Workflow List

Referencing another workflow list is accomplished by first creating a segmentation tree and using the desired workflow list as a result list. This enables the end user to conditionally execute the workflow list.

Attaching a Workflow List to a Segmentation Tree

When the end user defines an end results node in a segmentation tree, the end user assigns a workflow list to serve as the result list for that node. The end user can attach any workflow list, except for the root workflow list. The root workflow list is the main workflow list and a reference from a segmentation tree will result in a circular reference.

Using Other Resources Details

Other resources include User Defined Functions (UDFs) and Models. These parts enable the end user to add more complexity to the decision engine.

Working with Models

Models seek to identify and mathematically represent underlying relationships in historical data, in order to explain the data and make predictions or classifications about new data. An analyst develops a model in order to make specific predictions based on real-world data.

What is a Model?

There are several kinds of models that can be used for predictive analysis. In a preferred embodiment, models are made up of characteristics that can be discrete integers, continuous range integers, or expressions. For example, models would be useful in situations where mergers, or changes to billing processes or procedures create the same errors consistently over a population of bills.

A discrete additive model is a scoring formula represented by a sum of terms, wherein each term is a non-linear function for a single predictor variable. Such models generally refer to relationships that exhibit no high order interaction or association. Additive models are of the form:
y−f1(X1)+f2(X2)+fn(Xn)
wherein each of the functions f n (X n) depends only on variable.

In the case of a discrete additive model, f(X) is represented by a mutually exclusive, collectively exhaustive set of indictor variables. A model includes one or more characteristics. Each characteristic is mapped to a variable and will take on some value during the runtime execution and score calculation. The variable itself may have been calculated and may depend on other variables and input fields within the project. A partial score is calculated for a characteristic by determining the attribute to be associated with the particular value of a characteristic. A weight value is a function of this attribute, and it is assigned to the partial score. The partial scores are added together to determine the total score.

Reasons (in the form of codes and/or strings) are also determined during the process of calculating a score. Several algorithms can be used to determine and assign reasons.

Setting Project-Level Properties

Some model properties apply to all models in a project, rather than to an individual model. Such properties affect the way that the designer generates data structure parts and functions when the end user creates the first model for a project. The end user can modify these properties after adding or importing models to the project.

Score Weights

The score (also called a score weight or partial score) is the primary output/result of a model. The secondary (optional) output is score reasons. For each characteristic, a partial score is calculated based on the characteristic's attribute/value. For example, at runtime, the characteristic of “number of late payments” will assign a score to each transaction. This score is weighed according to the attribute value, which is assigned a score based on the actual runtime value according to the attribute match. Such partial scores are then added to determine a total score for that model.

The score weight data type can be either integer or floating point. The end user can indicate whether expressions are allowed in score weights. If this option is selected, score weights can be defined as any one or a combination of the following: literal numeric value, a data field (input, local, constant, or derived) with a numeric value (integer or float) a valid VarGen arithmetic expression.

Score Reasons

In project level models properties, the end user indicates whether or not to use score reasons. By including score reasons in models, the end user can incorporate reason codes (adverse action codes) into models.

Model Generated Parts

Model generated parts include both global parts used by all models within a project and a UDF part specific to a particular model. If models already exist in the project and the end user creates a new model, the only part that is created with the new model is its corresponding UDF.

Reason Codes and Messages

A Reason_Code_List value list is a generated data structure for storing reason codes and messages. The base data type of this value list is string. It maintains the list of reason codes, with the reason messages store in the description field of the constant. The order of the codes in the value list determines the reason rank. This ranking is used when the score reason distances option is not selected for returning reason codes. For example, if the maximum reasons to return is set to three and there are more than three codes that can be returned, the top three reasons are determined by their rank (order) within this value list. If the end user is computing distances, the top three reasons are determined by computed distances, and this ranking is used for tie-breakers.

Reason codes and messages have one-to-one mapping. The end user can only have one set of reason codes and messages to use within a project, and most user typically work with a standard set of codes/reasons for all of their projects.

All Other Attributes

In the development of a predictive model, an analyst will select development sample data that are representative of the future population to be scored. Unforeseen circumstances, such as changes to an application or a new data entry system, can result in new data values that are not taken into account in predictive model development or the resulting predictive model. Accounting for the possibility of such data through the assignment of a score weight and adverse action code for another attribute range allows for the computation of response at runtime.

Unexpected Flag

Data values explicitly accounted for in Model development may still be unexpected at runtime. For example, even though the occurrence of a customer service outage corresponding to no report of a service outage is a defined look-up in the decision model, it may represent an unexpected, unanticipated occurrence. The end user may want to flag it and other such unexpected values and track occurrence over time. A high frequency of occurrence of unexpected values may warrant to redevelopment of the scoring model. Furthermore, if data values for several model characteristics fall into an unexpected range, the resulting predictions may be invalid.

The model score is composed of the partial scores of one or more characteristics. If the total score is the result of too many unexpected values, then the score may be invalid. What constitutes an invalid score will be a function of the number of model characteristics (the more characteristics, the less likely that a few unexpected characteristics will skew the data or have a large impact on the result score) and the end user's individual tolerance for unexpected values in the data. For example, in a fraud detection environment, 0 unexpected values may be tolerated in the computation of a valid prediction.

The threshold can be implemented in the project workflow within a segmentation tree or an expression sequence using the following logic, based on the output from the “Number of Unexpected Values”:

If ( ( nb_expected > 3)
{
Invalid_score_flag = TRUE
]

The user can output the “Number of Unexpected Values” to track the number.

Special Values

The “Special Value_Mappings” value list is created when the scoring package is created. This list is populated with default values and these values can be assigned to range/values in a model. Because many models are developed using SAS data sets, this may be used to specify values that indicate specific conditions.

Model Results

Part of the Model-generated parts are the segments that report the scoring results. These segements are: “ML_Scores,” “ML_Scored_Characteristics,” “ML_Reasons,” and “ML_Reason_Computation.” They contain local fields which hold the different pieces of results information and are used for all models. At runtime, the last invoked model UDF produces the results. The end user can view the results and designate any of the local fields within these segments to be written to output at runtime.

Importing a Model

In the designer, the end user can directly import models using a decision system model XML format into an open project the end user has checked out. By default, the designer does not automatically generate a sub-population characteristic for imported models, however, if one exists, the model is created accordingly.

Initial Score

When the end user creates a new model, the end user can specify an initial score. This value is used to align scores when multiple models are used within a project. Multiple Models can be created for handling multiple subpopulations within a single project, i.e. short time as customer of record, long time as customer of record and delinquent frequently, long time as customer of record and rarely delinquent, etc. The output for each subpopulation is initially an unscaled score. Each sub-population is then aligned to a certain good/bad odds scale, such that a score in one sub-population will have equivalent odds to an identical score in another sub-population. The difference is odds across subpopulations is taken into account and an initial value is calculated to adjust the score of an individual model.

Model Properties

The model properties are those properties define when a new model part is created.

Using Defined Fields

When a model is defined, the end user maps model characteristics to other data fields.

Working with a Model

The scoring model is presented in a table with model characteristics and attributes as well as the score associated with each attribute. The model calculates the score for each data record that passes through at runtime. The score is the numerical total of points awarded based on the data evaluated by the scoring model, or a total of the score associated with each attribute in the model.

Characteristics and Attributes

A model consists of a series of characteristics and their attributes. The model assesses each data record at the characteristic level, and assigns a score based on the attribute of the data record for that characteristic. The end user inserts characteristics and their attributes into a grid structure.

Characteristics

A characteristic is a predictive variable; specific information used to predict a future outcome and compute a score. Different types a characteristics can be used in a model.

A continuous characteristic, such as length of time as a customer, has a continuous set of values. For example, length of time could range from 1 month to 192 months. Another examples might include revenue generated in dollars, or time at a given service address.

A discrete characteristic, such as type of service provided, number of minutes used, is where no relationship exists between the various attributes (answers or values) that might be provided.

A generated characteristic is one generated from two or more variables. For example, a model might include a time at two addresses characteristic, which is generated from time at address and time at previous address characteristics.

Assigning Data Fields

The end user can create fields in the project inventory and assign them to characteristics in a scoring model. The end user can assign the following fields to a characteristic: constants, derived fields, and input or local fields that are not part of an array or segment group. The base type of these fields can be integer, string, or floating point. Defining a model may include creating a series of characteristics and their attributes.

Attributes

An attribute defines one or more characteristic range/values. For example, an individual with basic residential service on two lines with service for one year has the attribute of “2” for the characteristic “Number of Lines” and the attribute of “12” for “Number of months in Service” The “All Other” attribute is automatically created for each characteristic as a catch-all for all non-explicitly specified attribute ranges. In order to account for data values undefined in model development, the attributes of a characteristic provide mutually exclusive, collectively exhaustive coverage of all possible values over the data components' domain. The end user cannot delete this attribute.

Assigning Range/Values

When the end user defines an attribute, the end user assigns a range/value to the attribute. The range/value can be a floating point, integer continuous, integer discrete, or string based on the type setting for the characteristic.

Reason Codes and Messages

The “Reason_Code_List” is a value list, and each reason code is a constant within that value list and its message is the description of the constant. The “ML_Reasons” part is a segment that holds all of the reason code results, as specified by the maximum number to return in the project-level properties. The “ML_Reasons” segment consists of the “ML_Reason_Code,” “ML_Reason_Rank,” and ML_Reason_Distance” local fields.

Computing Score Reasons Distances

The end user can choose to compute distances based on maximum scores (distance=score weight−maximum score) or user-specified baseline scores (distance=score weight−baseline score). However, if the end user allows score weight expressions, the end user is limited to baseline scores. At runtime, the score reasons distances method returns score reason using a summed distance or maximum distance. Reason codes that have a positive distance are returned. Reason codes with zero or negative distances are not returned.

Return Method

When the end user calculates score reason distances, the end user also specifies a method for returning score reasons. This affects the way that reason codes are sorted and then returned at runtime. The end user can choose either a summed distance by code method or a maximum distance by code method.

Summed Distance by Code

This method combines the distances for reason codes that are returned for more than one characteristic. These summed distances are sorted in descending order, with a secondary sort by reason rank in ascending order. Next the top N reason codes are returned by summed distance (where N is the maximum number to return) with reason rank used as a tie-breaker.

Maximum Distance by Code

This method evaluates reason codes based on the distance calculated for each characteristic. With this method, the distances are computed and sorted in ascending order, with a secondary sort by reason rank in ascending order. Next, the top N unique reason codes are returned by distance (where N is the maximum number to return) with reason rank used as a tie-breaker.

Using Reason Ranking

If score reason distances are not calculated, then the reason rank method is used. The relative rank (position) is determined by the order in which the reason codes are defined in the “Reason_Code_List” value list.

The model uses a hardwired distance method as the algorithm for calculations of reasons. Each attribute in a characteristic is assigned a reason code. Each reason code has a relative rank based on its position in the Reason_Code_List value list. Therefore, within a project, a reason code can only have one unique rank.

Subpopulation Characteristics

The subpopulation characteristic is used in conjunction with reason code computation. A subpopulation is a distinct grouping of individual records having similar qualities or characteristics within the group, but whose qualities are different than other groups. A sub-population has two attributes: “True” and “Other Subpops.”

The subpopulation characteristic is treated like any other characteristic in score reason computation. The end user can modify a baseline score if use and the score for the “Other Subpops” attribute, which are used for computing distances. The end user can also modify reason codes for both attributes. For example, models can be created for multiple subpopulations, i.e. a short time as a customer, a long time as a customer, etc. In order to indicate the contribution of the subpopulation to the score weights, the analyst uses an artificial characteristic. This artificial characteristic is a subpopulation indicator with two attributes (True, Other Subpops). For a specific subpopulation, all members of that subpopulation should fall into the “True” attribute.

The current convention is to assign a weight of 0 to the “True” attribute, and to assign a weight reflecting the difference between the subpopulation and the total population odds for the “Other Subpops” attribute. If the end user wants to ensure that the subpopulation characteristic will always be returned with a score reason, then the end user assigns the “Other Subpops” attribute a very large weight, such as 900. In this way, the “Other Subpops” score effectively acts as a baseline score.

The “True” Attribute

The first default attribute in the subpopulation characteristic is labeled “True” and ahs arrange/value of 1 and a description of “always true.” The score default is 0.00 if a floating point is used and 0 if an integer is used. An unexpected checkbox is selected and the reason code and message are blank by default. Only the reason code and the message is editable, while all other properties associated with this attribute cannot be changed. At runtime, any transaction being scored with this model falls into the “true” Attribute of the subpopulation characteristic.

The “OtherSubpops” Attribute

The second default attribute in the Subpopulation characteristic is labeled “OtherSubpops” and has a range/value of 0 and no description. The score default is 0.00 if a floating point is used and 0 if an integer is used. This should be set appropriately for reason code computation. An unexpected checkbox is selected and the reason code and message are blank by default. Only the reason code, message (if used), and the score are editable, all other properties associated with this attribute cannot be changed.

Editing Characteristics and Attributes

If an end user changes project-level model properties, the result is some changes to existing models within a project. At any point in a project design, the end user can also edit any project model. Editing a project model involves modifications to the existing characteristics and attributes within a model. The end user can add new characteristics and attributes, as well as modify or remove existing ones.

Validations

The end user can verify the content of a model at any time from a model editor, or can rely on an automated validation process when marking the project for testing or production.

Marking a Project for Production or Testing

Model validation occurs automatically when and end user marks a project for productions or testing. If any model errors are found, they are displayed in a process output window, as with any other errors during such procedures. If the mark for production/testing validations are successful, then the decision system generates code in the model UDF. If a model is encrypted, the generated UDF is also encrypted. When an end user unmarks a project for testing or production, the model UDF returns to its previous state.

Working with Model-Generated Parts

Some model generated parts, such as those beginning with “ML_”, cannot be edited, except a write to output option, Fields within the “ML_Scores” and ML_Reasons” segments are set to write to output by default, but other segment fields are not. The end user can change the write to output settings of these parts according to the desired output. The end user can also make some content modifications to some of the other generated parts, including reason codes and special value mappings parts. When the end use deletes the last model so that not model parts in the project inventory remain, the generated prediction parts are removed unless referenced by another project part. These exceptions are the “Reason_Code_List” and “Special_Mapping_Value” value list. These parts are not removed unless the end user manually deletes them. For every additional model created for a project, a new model part and UDF part are generated. When the model is deleted, its UDF is automatically removed. For projects with more than one model, the last model UDF invoked at runtime generates the results.

Working with UDFs

A UDF (User-Defined Function) represents the logic to be contained in a single subroutine and returns one value. The data type of the return value defines the data type of the UDF. For example, and end user wants to calculate the sum of an array, or segment. The end user can accomplish this with a UDF expression.

A UDF specifies a simple set of operations that manipulates input data values, possibly combining and transforming them into new values, and returns a single typed value. Physically, a UDF consists of a set of text statements written in a programming language.

Public and Private UDFs

When an end user creates a UDF, the end user specifies whether it is a public or private UDF, to determine the scope of the UDF and how it is used within a project.

Public Functions

In the decision system, a public function is defined as callable for anywhere within the project. It may be called from any expression in any segmentation tree node or expression sequence (if it does not take parameters), a model score weight expression, any other USF, or anywhere text statements is allowed. It may also be associated with a derived field within the project (if it does not take parameters), and be invoked when that derived field is referenced. A public function may take any number of parameters, but there are restrictions on where it may be used.

Private Functions

A private function differs from a public function in that it may be called only from other UDFs in the same project. It cannot be called from an expression in a segmentation tree node, and it may not be associated with a derived field data component, expression sequence, or model.

Return Type

Each function has a return value. When the end user creates a new UDF, the end user sets the return type. The return type can be an integer, float, or string data type.

Calling User Defined Functions

User Defined Functions may be called according to the following: From an expression in a segmentation tree node, expression sequence, or model score weight,

By referencing a derived field data component that is associated with that UDF; and

From within another UDF. Functions that accept parameters may not be called from anywhere except from within another UDF. For example, UDFs associated with derived field data components may only be associated with functions not taking parameters. Similarly, a function called from an expression in a segmentation tree node also does not take parameters.

Parameters

UDFs may accept any number of parameter arguments, separated by commas: Function (param1, param2, . . . , paramN), where each parameter is the legal name of either: a data field of type integer, float, or string; or an array group of type integer, float, or string.

The names are preferably unique only within that UDF. Semantically, parameters are passed by value only. Through the runtime implementation of the language may or may not pass parameters to the function by reference for performance reasons, the value of any parameter changed inside a function is not transmitted or available outside the function after the call, unless it is assigned as the return value of the function or to a local field.

The end user can define any number of local variables for a function from the three basic data types, integer, float, or string. Local variables are fields are can only be referenced by the UDF for which they have been specified. They are preferably initialized at the beginning of the UDF and do not retain their values in subsequent executions of the function. The scope of local variables is the logic of that function. Only local variables and local field data components may be assigned values within a UDF. No other data component type may be assigned a value. Assignment to a “this” local variable is the only means of transmitting a value back out of a function.

The “this” Local Variable

A predefined “this” local variable is always available in function logic. The “this” variable represents the return value of the function, and so, by definition, is of the same type as the specified return type of the function. To return a value from a function, simply assign the desired value to the “this” local variable in an assignment statement, for example: this=(AverageBalance/100)*2.

The “this” variable has an initial default return value based on the function return type, so if no value is assigned to the “this” variable in the function's logic, its initial value will be returned by the rule: if the function returns string, integer, and float, then “this” is initially set to empty/null string, 0,0.0. respectively.

The present invention is not limited to the embodiments described above herein, which may be amended or modified without departing from the scope of the present invention as set forth in the appended claims, and structural and functional equivalents thereof.

In methods that may be performed according to preferred embodiments herein and that may have been described above and/or claimed below, the operations have been described in selected typographical sequences. However, the sequences have been selected and so ordered for typographical convenience and are not intended to imply any particular order for performing the operations.

In addition, all references cited herein, in addition to the background and summary of the invention sections, in addition to U.S. Pat. Nos. 5,495,412, 5,895,450, 6,144,726, 6,856,984, 5,668,953, 6,330,551, 6,766,307, 6,850,918, and United States published patent applications nos. 2004/0128155, 2004/0059596, 2002/0198830, 2003/0014265, 2003/0233292, 2003/0236679, 2004/0034596, 2004/0148234, 2005/0187884, are hereby incorporated by reference into the detailed description of the preferred embodiments as disclosing components of alternative embodiments.

What is claimed is:

1. A computer-implemented dispute resolution method, comprising:
(a) receiving a dispute query from a user;
(b) generating a record based on the dispute query;
(c) electronically generating a decision, including applying said record to a workflow algorithm including representations of one or more business rules, one or more segmentation or decision trees or both, one or more expression sequences, one or more data structures, one or more user-defined functions, or one or more decision models, or combinations thereof;
(d) determining whether to gather further information or take other further action based on said decision;
(e) updating the record according to said decision;
(f) storing the record; and
(f) communicating a result of the dispute query to the user based on the record.

2. The method of claim 1, wherein the generating of the record comprises inputting information relating to the dispute query to a secure gateway for translation of the information, and populating the record with translated information.

3. The method of claim 1, wherein when it is determined to gather further information prior to generating a decision, then gathering said further information.

4. The method of claim 3, wherein said further information comprises user account information or history or both, type or amount of the dispute or both, external report information, consumer statistics, tariff or regulatory information or both, one or more contracts, or combinations thereof.

5. The method of claim 4, further comprising ordering said further information using the internet.

6. The method of claim 4, further comprising retrieving said further information from one or more internal resource locations

7. The method of claim 1, further comprising testing said workflow algorithm.

8. The method of claim 7, further comprising documenting results of said testing for use in an audit.

9. The method of claim 7, further comprising updating said workflow algorithm based on results of said testing.

10. The method of claim 1, wherein said other further action comprises involving a human specialist.

11. One or more processor readable storage devices having processor readable code embodied thereon, said processor readable code for programming one or more processors to perform a computer-implemented dispute resolution method, the method comprising:
(a) receiving a dispute query from a user;
(b) generating a record based on the dispute query;
(c) electronically generating a decision, including applying said record to a workflow algorithm including representations of one or more business rules, one or more segmentation or decision trees or both, one or more expression sequences, one or more data structures, one or more user-defined functions, or one or more decision models, or combinations thereof;
(d) determining whether to gather further information or take other further action based on said decision;
(e) updating the record according to said decision;
(f) storing the record; and
(f) communicating a result of the dispute query to the user based on the record.

12. The one or more storage devices of claim 11, wherein the generating of the record comprises inputting information relating to the dispute query to a secure gateway for translation of the information, and populating the record with translated information.

13. The one or more storage devices of claim 11, wherein when it is determined to gather further information prior to generating a decision, then the method further comprises gathering said further information.

14. The one or more storage devices of claim 13, wherein said further information comprises user account information or history or both, type or amount of the dispute or both, external report information, consumer statistics, tariff or regulatory information or both, one or more contracts, or combinations thereof.

15. The one or more storage devices of claim 14, wherein the method further comprises ordering said further information using the internet.

16. The one or more storage devices of claim 14, wherein the method further comprises retrieving said further information from one or more internal resource locations

17. The one or more storage devices of claim 11, wherein the method further comprises testing said workflow algorithm.

18. The one or more storage devices of claim 17, wherein the method further comprises documenting results of said testing for use in an audit.

19. The one or more storage devices of claim 17, wherein the method further comprises updating said workflow algorithm based on results of said testing.

20. The one or more storage devices of claim 11, wherein said other further action comprises involving a human specialist.

21. A microprocessor-based apparatus configured within a computer network for receiving a dispute query, generating a decision regarding said query, and communicating a result of the query, the apparatus including one or more microprocessors and one or more digital memories having stored therein a computer-implemented design component architecture that comprises:
(a) a designer component for configuring a decision engine including a workflow algorithm;
(b) a reporting facility component for generating configuration or testing reports, or both, relating to operation of said decision engine; and
(c) a run-time server for executing the decision engine by applying said dispute query to the workflow algorithm for generating said decision.

22. The apparatus of claim 21, further comprising a program requester for generating one or more modules representing one or more business rules, one or more segmentation or decision trees or both, one or more expression sequences, one or more data structures, one or more user-defined functions, or one or more decision models, or combinations thereof, to be integrated as part of said workflow algorithm.

23. The apparatus of claim 21, wherein the one or more digital memories further have stored therein a record generator that inputs information relating to the dispute query to a secure gateway for translating the information, and that populates the record with translated information.

24. The apparatus of claim 21, wherein the one or more digital memories further have stored therein an information gathering component for gathering further information before communicating said result including user account information or history or both, type or amount of the dispute or both, external report information, consumer statistics, tariff or regulatory information or both, one or more contracts, or combinations thereof.

25. The apparatus of claim 24, wherein the gathering comprises ordering said further information using the internet.

26. The apparatus of claim 24, wherein the gathering comprises retrieving said further information from one or more internal resource locations

27. The apparatus of claim 21, wherein the designer component is configured to update the workflow algorithm based on results of said testing.

28. A dispute resolution method for determining and delivering a decision to an end user based on a dispute query received from said end user using decision trees, models, rules or external reports, or combinations thereof, the method comprising:
(a) providing a secure internet gateway for receiving said dispute query from said end user and subsequently translating said query for processing;
(b) inserting translated information of said query into a standard record;
(c) passing said standard record to a decision system;
(d) analyzing said query information using said decision trees, models, or rules, or combinations thereof,
(e) generating a resolution based on said analyzing,
(f) updating said standard record with said generated resolution;
(g) determining whether said dispute query requires further action based on said resolution;
(h) passing said standard record directly to a relational database for storage when it is determined that no further action is required; and
(i) returning some or all of the resolution through said gateway to said end user.

29. The method of claim 28, further comprising:
(g1) passing said standard record to a secondary review system when it is determined that further action is required;
(g2) analyzing said standard record and determining additional information that is required;
(g3) determining whether additional information has been received;
(g4) when it is determined that said additional information has not been received, then placing a message in said standard record indicating delay; and
(g5) when it is determined that said additional information has been received, then passing data from said additional information in said standard record, and returning to passing said standard record to a decision system.

30. The method of claim 29, further comprising invoking appropriate protocols for each of said additional information.

31. The method of claim 28, wherein the method involves a plurality of end users, a plurality of actions, and a plurality of dispute resolution actions and decisions.

32. The method of claim 28, further comprising operating said gateway ASP mode.

33. The method of claim 32, further comprising utilizing a XML interface.

34. The method of claim 28, wherein said database comprises data elements generated during the analyzing, said dispute query, and said translated information.

35. The method of claim 34, further comprising utilizing said database for reporting, tracking, or future analysis, or combinations thereof.

36. The method of claim 35, further comprising updating said decision trees, models or rules, or combinations thereof, based upon said utilizing of said database.

37. The method of claim 28, further comprising accessing an initial dispute resolution process or a secondary process, or both, for handling continuing disputes or arbitration or mediation transactions, or combinations thereof, and wherein said accessing being dependent upon one or more external data requirements.

38. The method of claim 28, wherein the dispute relates to a billing charge or process, or service.

39. One or more processor readable storage devices having processor readable code embodied thereon, said processor readable code for programming one or more processors to perform a computer-implemented dispute resolution method, the method comprising:
(a) providing a secure internet gateway for receiving a dispute query from an end user and subsequently translating said query for processing;
(b) inserting translated information of said query into a standard record;
(c) passing said standard record to a decision system;
(d) analyzing said query information using one or more decision trees, models, or rules, or combinations thereof;
(e) generating a resolution based on said analyzing,
(f) updating said standard record with said generated resolution;
(g) determining whether said dispute query requires further action based on said resolution;
(h) passing said standard record directly to a relational database for storage when it is determined that no further action is required; and
(i) returning some or all of the resolution through said gateway to said end user.

40. The one or more storage devices of claim 39, the method further comprising:
(g1) passing said standard record to a secondary review system when it is determined that further action is required;
(g2) analyzing said standard record and determining additional information that is required;
(g3) determining whether additional information has been received;
(g4) when it is determined that said additional information has not been received, then placing a message in said standard record indicating delay; and
(g5) when it is determined that said additional information has been received, then passing data from said additional information in said standard record, and returning to passing said standard record to a decision system.

41. The one or more storage devices of claim 40, the method further comprising invoking appropriate protocols for each of said additional information.

42. The one or more storage devices of claim 39, wherein the method involves a plurality of end users, a plurality of actions, and a plurality of dispute resolution actions and decisions.

43. The one or more storage devices of claim 39, the method further comprising operating said gateway ASP mode.

44. The one or more storage devices of claim 43, the method further comprising utilizing a XML interface.

45. The one or more storage devices of claim 39, wherein said database comprises data elements generated during the analyzing, said dispute query, and said translated information.

46. The one or more storage devices of claim 45, the method further comprising utilizing said database for reporting, tracking, or future analysis, or combinations thereof.

47. The one or more storage devices of claim 46, the method further comprising updating said decision trees, models or rules, or combinations thereof, based upon said utilizing of said database.

48. The one or more storage devices of claim 39, the method further comprising accessing an initial dispute resolution process or a secondary process, or both, for handling continuing disputes or arbitration or mediation transactions, or combinations thereof, and wherein said accessing being dependent upon one or more external data requirements.

49. The one or more storage devices of claim 28, wherein the dispute relates to a billing charge or process, or service.
